(19) United States
(12) Patent Application Publication
(10) Pub. No.: US 2002/0140740 A1
(43) Pub. Date: Oct. 3, 2002

(54) Method for previewing an effect applied to a multimedia object

(76) Inventor: Chien-An Chen, Tainan (TW)

Correspondence Address: BIRCH STEWART KOLASCH & BIRCH, PO BOX 747, FALLS CHURCH, VA, 22040-0747, US

(21) Appl. No.: 09/924,530

(22) Filed: Aug. 9, 2001

(30) Foreign Application Priority Data
Mar. 30, 2001 (TW) 90107641

(51) Int. Cl. G06F 3/00

(52) U.S. Cl. 345/810

(57) ABSTRACT

A method for previewing the result of a function's application to an object using a processing system comprising a pointing device and a display showing a movable pointer controlled by the pointing device comprises the steps of storing the object and function in the system, displaying an icon representing the function on the display, outputting a preview generated by applying the function to the object when the pointer is moved onto the icon, and replacing the object with the application result of the function to the object.

### BACKGROUND OF THE INVENTION

1. Field of the Invention

The present invention relates to a method for previewing the result of a function's application to an object, particularly to a method for previewing an effect applied to a multimedia object whereby users can preview various effects quickly and easily prior to making decisions regarding the application of a function.

2. Description of the Prior Art

Various effects are used in multimedia production, including edging and brushing effects for images/layers, fade-out and fade-in effects for videos, frequency filtering and conversion effects for sounds, and many others, all the result of functions being applied to the original image/layer, video or sound by way of a computer used by the editor.

Many multimedia authoring tools provide these effects so that an editor can choose between them to enhance a featured image/layer, video or sound. There is also a method for authoring multimedia production provided by U.S. Pat. No. 5,592,602. FIG. 1 is a diagram showing a main window 1 of a conventional multimedia authoring software application. The window 1 comprises an effect menu 11 allowing the editor to choose from various effects, and a panel 12 having effect icons 10a˜10i. When the editor wishes to preview the edging effect, for example, to an image 13(of a car), “Effect” is clicked to generate the effect menu 11 and “Edging” is chosen from the menu 11, or the icon 10d, representing the edging effect, is double-clicked. A pre-stored function corresponding to the edging effect is applied to the image 13 and a resulting image 20 appears, as shown in FIG. 2.

Next, if the editor chooses against the edging effect, “Edit” is clicked to generate an Edit menu 14, as shown in FIG. 3, and “Undo” is chosen from the edit menu. The image 13 is recovered and the editor can preview another effect.

However, the editor must double click the effect icons and choose “Undo” repeatedly in order to preview the various resulting images before making another choice, thus making it troublesome for the editor to choose between from effects.

### SUMMARY OF THE INVENTION

Therefore, the object of the present invention is to provide a method for previewing an effect applied to a multimedia object wherein the editor needs not repeatedly click or select menus or icons when previewing effects.

The present invention provides a method for previewing the result of a function's application on an object using a processing system comprising a pointing device and a display displaying a movable pointer controlled by the pointing device. The method comprises the steps of storing the object and function in the system, displaying an icon representing the function on the display, outputting a preview generated by applying the function to the object when the pointer is moved onto the icon, and replacing the object with the application result of the function to the object.

In the present invention, the editor needs only move the pointer onto the effect icons to preview the resulting image. No additional operation is required.

### BRIEF DESCRIPTION OF THE DRAWINGS

The following detailed description, given by way of example and not intended to limit the invention solely to the embodiments described herein, will best be understood in conjunction with the accompanying drawings, in which:

FIGS. 1˜3 are diagrams showing a GUI of a conventional multimedia authoring software application.

FIG. 4 is a diagram showing a multimedia processing system according to one embodiment of the invention.

FIG. 5˜7 are diagrams showing a GUI of a multimedia authoring software application according to one embodiment of the invention.

FIG. 8˜11 are diagrams showing a GUI of a multimedia authoring software application according to another embodiment of the invention.

FIG. 12 is a flowchart of the method for previewing the result of a function's application to an object according to one embodiment of the invention.

### DETAILED DESCRIPTION OF THE INVENTION

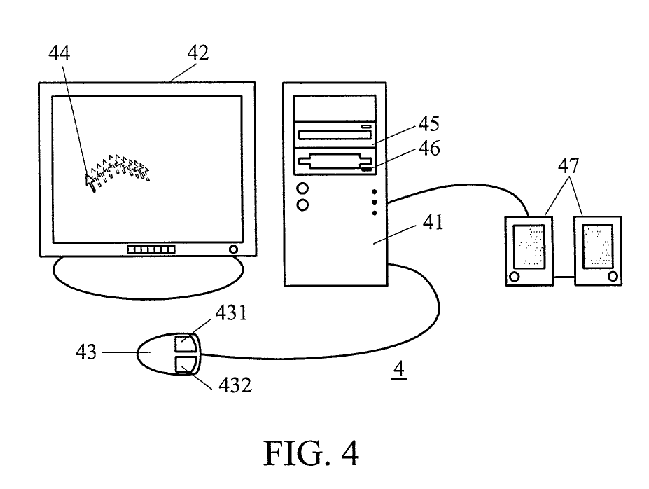

FIG. 4 shows a computer system used in the present invention. A computer system 4 comprises a host 41, a display 42, a mouse 43, a CD-ROM driver 45, a floppy disk driver 46 and a pair of speakers 47. Users install the invention, stored on a CD or floppy disk on the host 41, causing the computer system 4 to implement the invented method. The display 42 and speakers 47 output images and sounds. The mouse 43 generates a pointer 44 on the display 42 to indicate a pointed position, and has a left button 431, a right button 432 and a ball (not shown) on the bottom to allow clicking, right-clicking, and placement of the onscreen pointer, respectively.

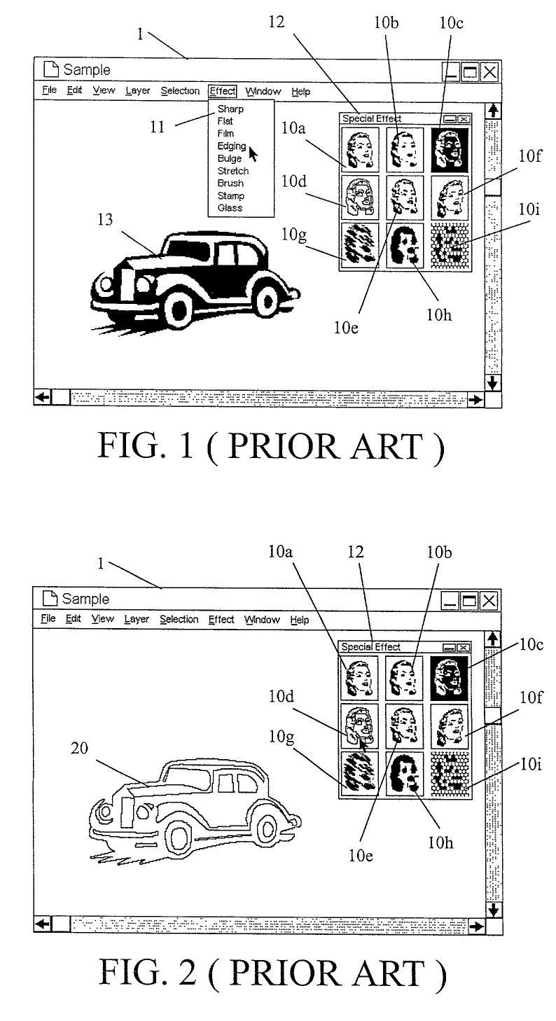

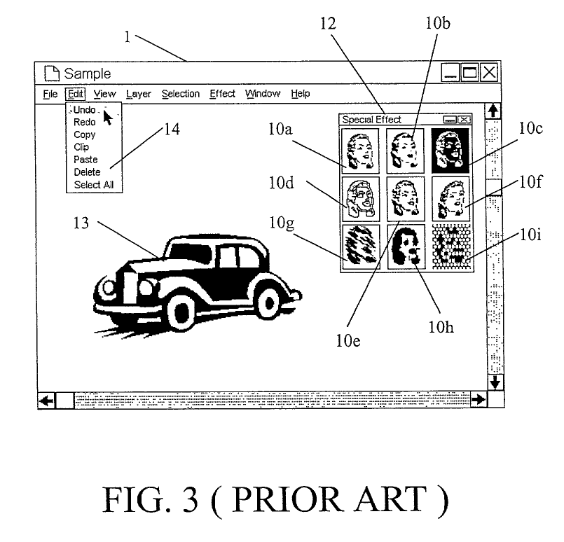

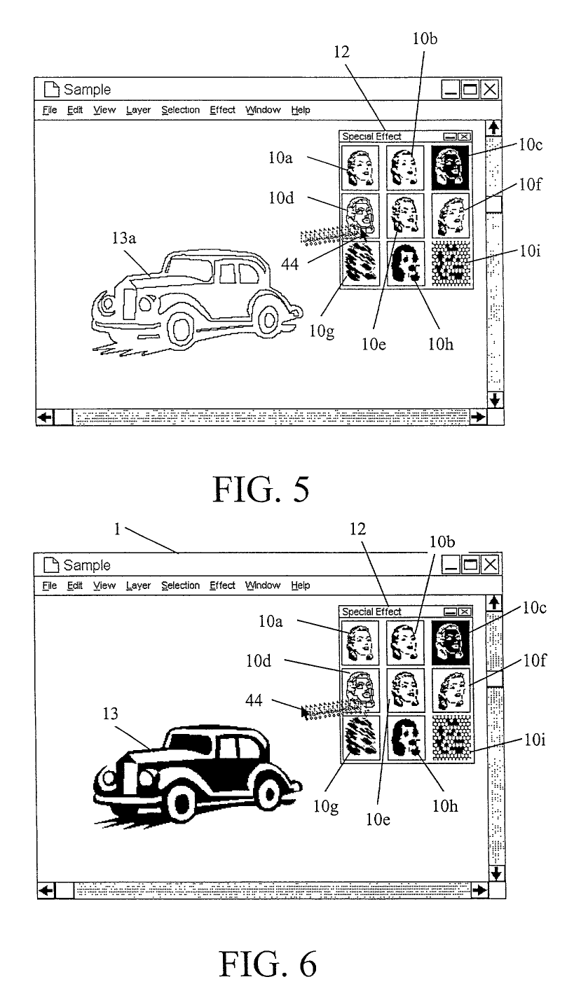

FIG. 5˜7 are diagrams showing a GUI of a multimedia authoring software application according to a first embodiment of the invention. For clarity, the same elements in FIG. 1, 2 and 5˜7 refer to the same symbols.

At the beginning, the original image object 13 and 20 functions corresponding to the effects represented by the icons 10a˜10i are pre-stored in the host 41.

Next, please refer to FIG. 5, in which a pointer 44 is moved along the dotted trace onto the icon 10d representing the edging effect. The pointer maintains this position about 1 second. The host 41 detects that the mouseover has lasted for more than 0.7 seconds, and accordingly applies the function corresponding to the edging effect to the object 13 to generate a preview object 13a. Then, the host 41 replaces the image of the object 13 with that of the object 13a. Since the editor is only previewing, the object 13 is still stored in the host 41.

Please refer to FIG. 6, in which the edging effect is declined and the pointer 44 is moved off of the icon 10d. The host 41 detects the termination of the mouseover and accordingly stops the display of the object 13a. The image of the object 13 appears again.

Please refer to FIG. 7, in which the edging effect is accepted. Double-clicking the icon 10d causes the host 41 to replace the original image object 13 with the resulting preview object 13a, so that the image of the object 13a appears on the display 42, irrespective of the pointer 44's position.

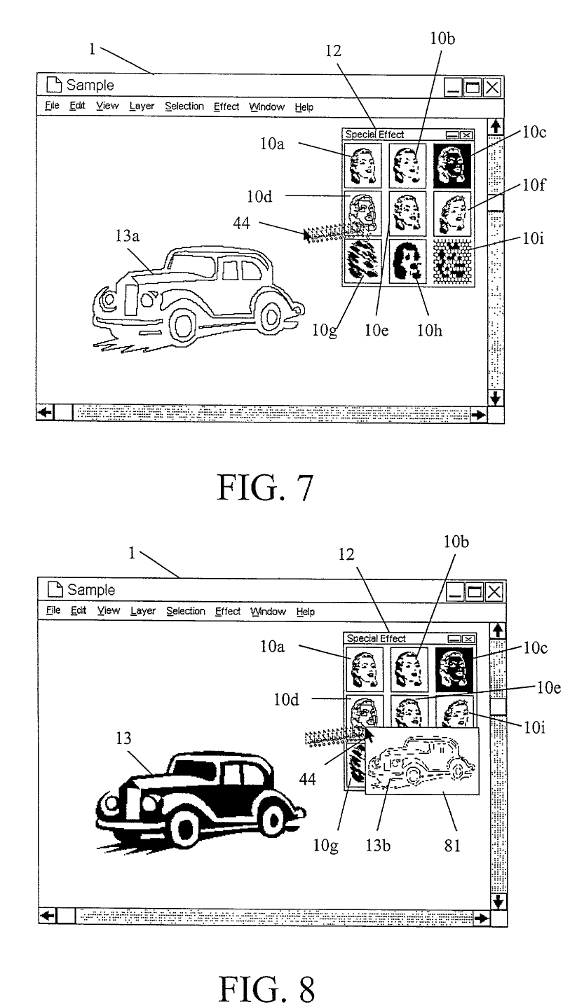

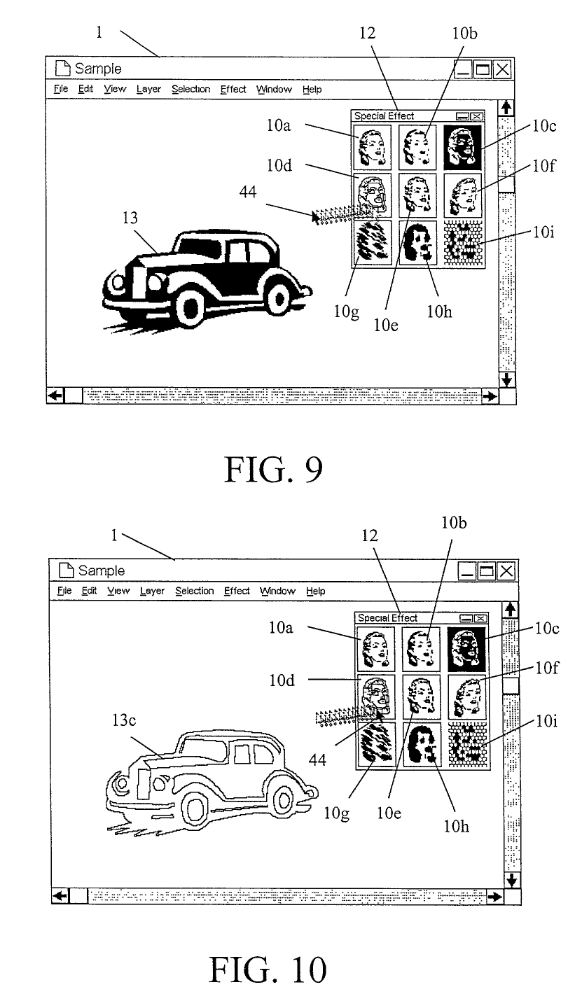

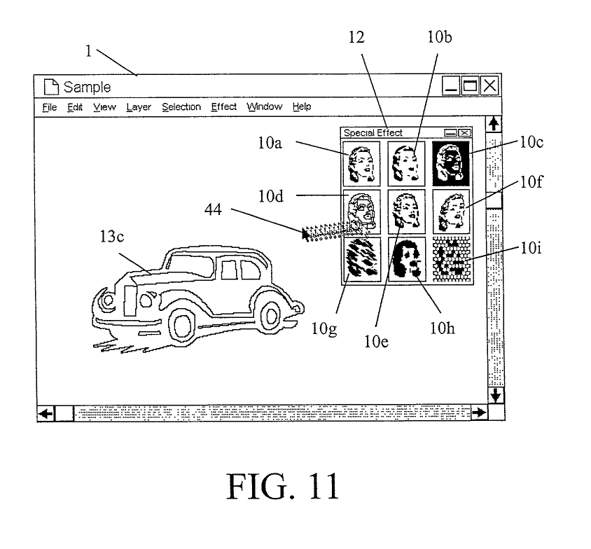

FIG. 8˜11 are diagrams showing a GUI of a multimedia authoring software application according to a second embodiment of the invention. For clarity, the same elements in FIG. 1, 2 and 8˜11 refer to the same symbols.

Initially, the original image object 13 and functions corresponding to the effects represented by the icons 10a˜10i are pre-stored in the host 41.

Next, FIG. 8 shows a pointer 44 moving along the dotted trace onto the icon 10d representing the edging effect. The pointer maintains this position about 1 second. The host 41 detects that the mouseover has lasted for longer than 0.7 seconds, and accordingly applies the function corresponding to the edging effect to the object 13 to generate a preview object 13b. Then, the host 41 generates a preview window 81 showing the image of the object 13b on the display 42.

Please refer to FIG. 9, in which the edging effect is declined and the pointer 44 is moved off of the icon 10d.

The host 41 detects the termination of the mouseover and accordingly closes the preview window 81 and terminates output of the object 13b to the display 42.

Please refer to FIG. 10, in which the edging effect is accepted. Double-clicking the icon 10d causes the host 41 to apply the function corresponding to the edging effect to the object 13 to generate a resulting object 13c and replaces the original image object 13 with the resulting object 13c so that the image of the object 13 is replaced with that of the object 13c in the display 42 irrespective of the pointer 44's position, as shown in FIG. 11. The preview window 81 showing the image of the object 13b is also closed.

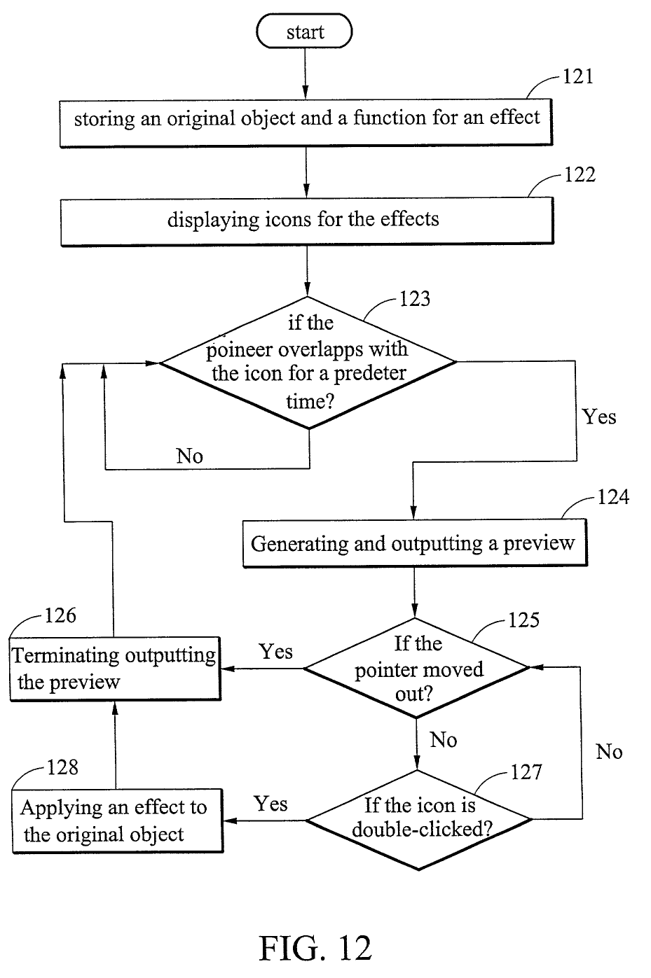

FIG. 12 is a flowchart of the method for previewing the result of a function's application to an object according to one embodiment of the invention. The method will be explained with FIG. 12 and FIG. 4.

In step 121, an original image object and functions corresponding to effects are pre-stored in the host 41.

In step 122, the host 41 displays icons representing the effects on the display 42.

In step 123, the host 41 detects the duration of the mouseover involving the pointer 44 and one of the icons. If the duration is longer than 0.7 seconds, step 124 is implemented, otherwise, step 123 is repeated.

In step 124, the host 41 applies the function corresponding to the effect represented by the icon which overlaps with the pointer 44 to the original object to generate a preview object and displays the image of the preview object on the display 42.

In step 125, the host 41 detects if the pointer 44 moves off of the icon. If so, step 126 is implemented, otherwise, step 127 is implemented.

In step 126, the host 41 terminates display of the image of the preview object and returns to step 123.

In step 127, the host 41 detects if the icon is double-clicked. If so, the original object is replaced with an object resulting from the application of the function or with the preview object, and the system returns to step 126. Otherwise, return to step 125.

In the previously described embodiments, the invention also applies to authoring of video and sound objects (the sound objects output by the speakers 47) although only image objects are mentioned for example purposes.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for previewing the result of a function's application to an object using a processing system comprising a pointing device and a display displaying a movable pointer controlled by the pointing device, the method comprising the steps of:
storing the object and function in the system;
displaying an icon representing the function on the display;
outputting a preview generated by applying the function to the object when the pointer is moved onto the icon; and
replacing the object with the result of the function's application to the object.

2. The method as claimed in claim 1 wherein the object is a multimedia object.

3. The method as claimed in claim 2 wherein the object is an image or a layer.

4. The method as claimed in claim 2 wherein the object is a video.

5. The method as claimed in claim 2 wherein the object is a sound.

6. The method as claimed in claim 1 wherein the function applies an effect to the object.

7. The method as claimed in claim 6 wherein the function applies an image effect to the object.

8. The method as claimed in claim 6 wherein the function applies a video effect to the object.

9. The method as claimed in claim 6 wherein the function applies a sound effect to the object.

10. The method as claimed in claim 1 wherein the preview is output when the pointer is moved onto the icon for a period of time.

11. The method as claimed in claim 1 wherein the object is replaced with the application result of the function to the object when an event is triggered.

12. The method as claimed in claim 11 wherein the pointing device is a mouse.

13. The method as claimed in claim 12 wherein the event is clicking the icon.

14. The method as claimed in claim 1 wherein the preview is output by the display.

15. The method as claimed in claim 1 wherein the processing system further comprises a speaker by which the preview is output.

16. The method as claimed in claim 1 further comprising the step of:
terminating outputting the preview when the pointer is moved out of the icon.

17. The method as claimed in claim 1 wherein the application result replacing the object is the preview.
